(19) United States
(12) Patent Application Publication
(10) Pub. No.: US 2007/0233601 A1
(43) Pub. Date: Oct. 4, 2007

(54) Systems and methods for protecting digital content

(76) Inventors: Mark W. Nakada, Salt Lake City, UT (US); Jon F. Butler, Salt Lake City, UT (US)

Correspondence Address: KENNETH E. HORTON;KIRTON & MCCONKLE, 60 EAST SOUTH TEMPLE, SUITE 1800, SALTLAKE CITY, UT, 84111, US

(21) Appl. No.: 11/455,458

(22) Filed: Jun. 19, 2006

Related U.S. Application Data
(60) Provisional application No. 60/788,974, filed on Apr. 4, 2006.

(51) Int. Cl. G06Q 99/00

(52) U.S. Cl. 705/51

(57) ABSTRACT

Systems and methods for using digital rights management (DRM) information to protect digital content. The DRM information does not refer to or use any characteristic(s) of the device on which it resides. Nor does the DRM information require a connection to a license server from the user device on which the content is used. Using the DRM allows the owner to make sure that her digital content is always protected despite the type or location of the device that contains the digital content, including whether the device containing the digital content can connect to a license server. The DRM can be therefore used to easily manage the use of the digital content, including access, transfer, distribution, and copying of the digital content.

### RELATED APPLICATIONS

This application claims priority of U.S. Provisional Application No. 60/788,974, the entire disclosure of which is incorporated herein by reference.

### FIELD

This application generally relates to systems and methods for managing and protecting digital content. In particular, this application relates to systems and methods for managing the rights to access or use digital content, as well as protecting the digital content from unauthorized copying and distribution.

### BACKGROUND

One issue impeding the widespread use and distribution of digital content via electronic means, including the Internet, is the lack of adequate protection of the rights belonging to the owners of the digital content. Often, those rights are abused during the distribution, dissemination, and use of digital content. In particular, it is difficult to prevent individuals from making unauthorized copies or unauthorized distributions of the digital content within current electronic systems containing personal computers, workstations, and other devices.

Many hardware-based attempts to prevent such unauthorized copying and distribution have proven unsuccessful. Indeed, the increase of broadband technologies will make it easier to distribute larger volumes of digital content electronically, thus removing one deterrent to this problem of unauthorized copying and distribution.

Software-based solutions, therefore, have been considered as another method of protecting the digital content. These software-based efforts have been termed “intellectual property rights management” (IPRM), “digital property rights management” (DPRM), “intellectual property management” (IPM), “rights management” (RM) and “electronic copyright management” (ECM) (collectively, Digital Rights Management “DRM”). Examples of DRM systems and methods are described in U.S. Pat. Nos. 4,646,234, 5,530,235, 5,634,012, 5,715,403, 5,794,217, 5,638,443, and 5,629,980, 6,748,539, 6,865,551, 6,832,319, 6,832,318, 6,976,009, and 6,748,360, the disclosures of which are incorporated herein by reference in their entirety.

DRM typically includes processes for associating rights to any content that is stored in a digital format, as well as processing, managing, and enforcing those rights. Limitations often imposed by DRM upon the uses or activities of a user may include, as examples, a limit on the number of computers on which the digital content can be used, a limit on the number of times that the content can be copied to a storage device, or a limit on the number of portable devices that the content can be uploaded to (“synched” to), among others. For example, a digital book could be accompanied by DRM information regulating how that digital book may be used (such as viewing, printing, or borrowing) and can be controlled by the software used to view the digital book.

Typically, a user downloads digital content to a computer so that the digital content can be accessed and/or used on that computer. When the user attempts to use/access the digital content, the software on that computer detects that DRM restrictions have been associated with the digital content and that a license is required from a license server before the content can be used/accessed. The computer obtains the needed license, which then becomes associated with that computer. Copying the digital content to a different device will cause the license to be invalid and prevent the user from distributing the licensed digital content to any other device unless another license is obtained for each additional device on which the digital content is copied. In certain instances, the digital content can be used on an additional device if the initial license was so configured.

Thus, DRM protects the rights of content owners when their digital content is transferred from the devices which the owners control to a device which a user controls. Users, however, have increasing started to use standalone electronic devices, often located in public places, in order to download and use digital content. Such standalone computers may be attended or unattended, and can include automated teller machines, airport check-in systems, touchscreen machines, and a variety of other devices (collectively referred to as kiosks).

Despite the convenience of distributing digital content via kiosks, sales of digital content via this mechanism have not been widely adopted for several reasons. One reason is the fear of unauthorized copying. The nature of some existing DRM information prevents effective implementation at a kiosk because the licenses permitting access to or use of the digital content are typically limited to personal computers and not a kiosk. Indeed, the portable devices may not be able to access/use the digital content because their nature may prevent them from connecting to a license server to obtain a license, making the content virtually useless on the device. Even when the existing DRM information can be adapted so that the licenses associated with digital content can be used with a kiosk, the existing DRM information is tied to the portable device and does not remain with the digital content if it is copied or distributed any subsequent device.

### SUMMARY

Systems and methods for using digital rights management (DRM) information to protect digital content are described herein. The DRM information does not refer to or use any characteristic(s) of the device on which it resides. Nor does the DRM information the device on which the content resides to connect to a license server. Using the DRM information allows the content owner to make sure that the digital content is always protected despite the type or location of the device that contains the digital content, including whether that device can connect to a license server. The DRM information can therefore be used to easily manage the use of the digital content, including access, transfer, distribution, and copying of the digital content.

### DESCRIPTION OF THE DRAWINGS

The following description can be better understood in light of the Figures, in which:

FIG. 1 depicts the conventional file structure of digital content and license information;

FIG. 2 illustrates one file structure of digital content and license information;

FIG. 3 depicts one system for obtaining and using licensed digital content:

FIG. 4 depicts one method for obtaining and using licensed digital content; and

FIG. 5 depicts another system for obtaining and using licensed digital content.

Together with the following description, the Figures demonstrate and explain the principles of the systems and methods for delivering digital content. In the Figures, the thickness and configuration of components may be exaggerated for clarity. The same reference numerals in different Figures represent the same component.

### DETAILED DESCRIPTION

The following description provides specific details in order to provide a thorough understanding. The skilled artisan, however, would understand that the systems and methods can be practiced without employing these specific details. Indeed, the systems and methods can be practiced by modifying the illustrated system and method and can be used in conjunction with apparatus and techniques conventionally used in the industry. For example, while the systems and methods are described as being used with a kiosk, they could be used with many types of wireless computing devices, consumer electronic devices, military devices, or others. As another example, while the systems and methods are described as being used for digital content, they could be used for managing, protecting, securely delivering, or controlling access to any electronic asset such as flash memory storage devices or sticks, digital player devices, mass storage devices, and mobile/cellular phones.

The systems and methods use DRM information to manage and protect digital content independent of the device on which the digital content resides. The systems and methods also use DRM information to manage and protect digital content without the need for the device containing the digital content to access a license server. Any systems and methods meeting either or both of these criteria can be used, including those described below.

These systems and methods can use a variety of configurations for the DRM information. The DRM information that is associated with any given digital content may include any number or combination of restrictions, including those that are enabled by any existing or future technology. Non-limiting examples of such restrictions include a restriction that visual or textual content not be printed in hardcopy; a restriction that copy-and-paste functions are disabled for textual content; a restriction that a music file may not be played after a certain date; a restriction that a music file may only be played a fixed number of times; and a restriction that a file may only be copied to another device—or otherwise distributed—a fixed number of times. Other examples of restrictions include limitations on the number of CDs that can be created from a music file, limitations on the number of computers that a music file may be played on, and limitations on the number of times that a music file can be copied and used within a music play list. Yet other examples of the restrictions are described in the patents mentioned above.

The DRM information can have multiple versions of a restriction. With multiple versions of the same restriction, alternative conditions for accessing and using the same digital content can be used for and given type of restriction. Thus, the same restriction can be tailored for different conditions that might arise when the digital content is used/accessed.

In some embodiments, the DRM information can have a transactional restriction and a specification restriction. The transactional restriction corresponds to the method in which the digital content may be used or distributed, including the restrictions listed above. The specification restriction specifies the conditions which must be satisfied prior to the transaction restriction being exercised.

Any types of specification restrictions known in the art can be used. One example is a copy count specification that limits the number of “copies” of the content which may be exercised simultaneously. Another example is a control specification that controls the interactions between the content owners and distributors. Another example of a specification restriction is a time specification that assigns a start date, duration, and/or finish date when the digital content may be used/accessed. Yet another example is a security specification that provides for various security mechanisms to be used. Still another example is an authorization specification that controls any authorization criteria that must be satisfied. Finally, incentive specifications that motivate the user to access use the digital content in a specific manner are another example of a specification restriction.

The restriction(s) in the DRM information can be used to manage/control any type of transaction known in the art, or combination of transactions, that uses the digital content. One type of transaction is a registration transaction where a secure channel with the user is established. Another example is a login transaction that can check the authenticity of a user. Another example is a billing transaction where a user pays for certain rights to the digital content. Another example is a copy transaction where one or more independent copies of the digital content can be made with the same or lesser rights. Another example is a transfer transaction where copies of the content are transferred to another location. Another example is a loan transaction for loaning or borrowing copies of digital content, after which they are automatically returned after a predetermined time period. Another example is a play transaction which uses the digital contents in some manner, i.e., reading a digital book. Another example is an extract transaction where a part of a digital content is used to create new digital content containing that part. Another example is an embed transaction where the whole digital content becomes part of another digital content. Yet other examples of these transactions include, as known in the art, print transactions, backup transactions, restore transactions, delete transactions, edit transactions, install transactions, and uninstall transactions.

The specific restrictions for any given DRM may be provided by anyone that comes in contact with the digital content. Examples of such persons include the owner (the “content provider”) of the content, an operator of a system or device on which the digital content permanently or temporarily resides, a party which distributes the content, a purchaser of the content, or a user of the content. Other examples of such persons include licensees, licensors, and partners of any of the above.

The DRM information can be associated with the digital content using any known technique. Examples of such techniques include using numeric associations between a license key and a hardware-based code; standard encryption algorithms using a password or pass phrase, assigning a unique content ID to each piece of digital content, and assigning a unique transactional ID to each piece of digital content, combination of digital content, and type or category of digital content. The transactional ID can contain any instructions and restrictions (including those listed above) that control how the associated content is managed and used on any given device. In some aspects, the transactional ID can be a unique number that is generated for a given digital content. That transactional ID may be associated with a database record defining the user that has purchased digital content and/or the exact digital content purchased. The DRM information may then be generated so that it is associated with the transactional ID in any manner so that the DRM information will enable the digital content to be used/accessed in accordance with the restrictions of the DRM information. For example consider a transaction in which user X purchases a copy of digital content Y and the use of digital content Y is restricted according to DRM information Z. A unique transaction ID number A is generated and optionally stored in a database so that number A is associated with user X and digital content Y. When user X uses the purchased digital content Y, the hardware and software will verify that the use comes from User X (or another person authorized by User X) and use the DRM information to restrict the use of the digital content based on the restrictions in DRM information Z.

In some instances, the DRM information, including a transactional ID, is associated with the digital content by being stored as part of the file containing the digital content, as shown in FIG. 2. Such information may be in a header or meta-information section of the file, or in other locations within the file or within a file system, according to the file format or file system used to store the particular digital content. In the prior art methods, as shown in FIG. 3, the DRM information is stored separate from the digital content itself, in a distinct license file, restrictions database, or similar logically detached location from the digital content. The prior art methods impose the disadvantage of not being able to transfer the digital content from place to place without special software and hardware that recognizes and tracks the link between the digital content and the associated DRM information that is required for that digital content to be used.

Conversely, when the DRM information is contained within the same file as the digital content, standard procedures can be used to move the digital content from one device to another without losing or destroying the association between the digital content and the DRM information that is required for use. Examples of the standard transfer procedures that can be used include all manner of copy or move operations using any known file system, such as FAT, FAT16, FAT32, ext2, ext3, HPFS, NTFS, NFS, XFS, AFS, and the like, as well as using any known interface or command method, such as command line execution, scripted execution, programmatic execution, or drag-and-drop or other user-controlled operation in which a file of information is transferred from one location within a device to another location within that device or another device.

In some embodiments, the DRM information can be associated with the digital content in the following manner. The file for the digital content is divided into two parts: a content part and a description part. The content part contains the main information of the digital content, i.e., a picture, text, or music. The description part contains any information that allows examination of the content part without accessing that content part.

The description part can contain a series of descriptor blocks (or blocks). The blocks can contain any amount desired information. For example, the blocks can include an identifier block to uniquely identify the content, a starting block to provide a starting address for the file, a length block to show the size of the file, a rights block where the granted rights and their status are maintained, or a restriction block for information about the restrictions present.

The DRM information that is contained in the description part of the file can be attached to the content part in a variety of ways. In some embodiments, the description part of the file is created separate from the content part and the two parts are combined to create the file. In these embodiments, the description part can be created before, after, or at the same time as the content part is created or obtained. In other embodiments, the description part and the content part are created as a whole rather than being combined into a whole.

In some embodiments, the blocks in the description part will be the same for an entire file and so will be attached all at the same time. In other embodiments, the blocks in the description part will be different and so may all be added at the same time or at different times. For example, a first set of blocks can be attached to the content part when the digital content is created. When the digital content is copied, transferred or loaned, a second (or third or fourth, etc . . . ) set of blocks can be specified and then attached.

The DRM information described above can be used with and/or associated with any type of digital content or combinations of digital content. Examples of digital content include music, movies, video games, software, mobile phone ring tones, electronic books, and other types of content. The format in which the digital content is stored is also virtually unlimited. Examples of the types of digital formats include pdf, doc, xls, jpeg, tiff, gif, xbm, pnm, mpeg2, mpeg4, wma, ogg, aac, and avi, as well as combinations thereof. Of course, the DRM information can be used with any digital formats or type of digital content created in the future.

The digital content itself may be provided by any source. In some embodiments, the digital content is directly provided by the owner of the digital content or indirectly by one or more third parties that that act on behalf of the owners of the content (content providers). Non-limiting examples of content providers include music publishers, recording companies, book publishers, mobile telephone companies, and video game manufacturers.

In some aspects, the digital content may contain or be associated with additional information other than the DRM information. One example of this additional information can comprise instructions indicating how the content may be used, distributed, sold, transmitted, or otherwise processed (“use instructions”). Another example of such additional information includes metatags. Yet another example of such additional information includes information identifying the owner, licensee, or performer associated with that digital content, as well as specific file information, including the file title and copyright information.

The metatags can contain any desired information. One type of metatag that can be used contains information about the type of digital content, such as a genre of music or movie, an artist, a content provider, or otherwise. The metatags may also indicate additional use instructions for all content that is provided, with distinct use instructions for each piece of content, or with use instructions based on parameters that can be used to classify content. For example, a content provider may indicate that music performed by musical artist A may be redistributed freely, without restriction, music performed by musical artist B may be redistributed freely when purchased at a set price, and music performed by musical artist C may be redistributed in a manner that permits the music to be copied to another computer three times, after which the music may not be copied to another computer, but only played (performed) on a computer where it is stored.

Examples of other types of additional information include a format element that identifies the format of the digital content, a provider element that can specify information about the content provider, a selection element specifying a content selection made by a user, a purchase element defining rules for purchasing the content, a blackout element for geographically restricting access to given content, a rating element specifying the rating level for a particular rating scale or standard (i.e., MPAA rating), device capabilities element for specifying the requirements for a device that receives the content, a cost element detailing the price of the content, a subscription element specifying those services on which a given piece of content is available for subscription purposes, an override element for overriding any of the other elements, an authorization element for authorizing any number of activities, a location element that specifies the location of the user, a renewal element that represents a possible set of renewal options for the content, or combinations thereof.

The digital content may optionally be encrypted in a manner to increase security of the digital content during storage or transmission. Any number of encryption methods known to those in the art may be used to implement this feature. Examples of such encryptions include both symmetrical and asymmetrical encryption using a variety of methods, including RSA, DES, Triple DES, Blowfish, ElGamal, RC4, and combinations thereof.

Once the DRM information has been associated with the digital content, it remains with that digital content on every device or apparatus on which the digital content resides (whether temporarily of permanently), stored, distributed, transferred, etc. The DRM information is linked to—or associated with—the digital content, but the DRM information is not dependent on the device on which the digital content is present. Therefore, the DRM information is not associated with any type of device or apparatus, nor with any particular device or apparatus. With conventional DRM, the information is based on or linked to the hardware of the specific device containing the digital content and therefore becomes associated with that particular device, permitting access to or use of the digital content from that particular device.

In some embodiments, the DRM information can optionally be associated with a specific device or type of device. In these embodiments, the DRM information can be configured so that when the digital content resides on a device, the DRM information stays linked with the digital content, but also becomes associated with the device. This configuration offers the advantage, among others, that digital content cannot be moved to an unrestricted number of devices, as doing so would enable an unrestricted number of individuals to obtain a copy of the digital content once the DRM information had been associated with the digital content. The DRM information can also be configured so that when the digital content resides on a device, the DRM information stops being linked to the digital content, and instead becomes associated with the device. An advantage of this configuration is that it permits a device, rather than a user or specific digital content, to be authorized (or trusted) so that any digital content placed on that device may be accessed because the device itself has been authorized. One example of this configuration would be a device in an authorized location, such as a library or computing center, but the content was not individually controlled by the DRM information, thereby allowing any information residing on an authorized device to be accessed.

The digital content and the associated DRM information can be used with any type of electronic device that can store or obtain any digital content. Examples of the devices include computers of all types including servers, workstations, desktops, laptops, blade servers, kiosks, special purpose computers, personal devices (like mp3 players, PDAs, mobile/cellular phones, pagers, text messaging devices, calendar or text information devices, and flash drive or flash memory storage devices), various computing appliances, embedded systems, and other digital storage devices.

In some aspects, such a device may comprise a kiosk. Kiosks have been conventionally used to offer digital content to users in instances where computers are not typically located. Using a kiosk, a user may select from available digital content at the kiosk and then obtain a copy of the digital content. This may be done by obtaining an audio CD or DVD containing the content; the digital content may also be downloaded to a portable device such as a portable music player or a portable storage device, including a USB-based solid state storage device, CompactFlash, Secure Digital card, MemoryStick, or other similar devices having the ability to store the digital content. The digital content may then be played directly from an audio CD, DVD, or similar format storage media; may be played directly on the device to which the digital content was transferred; or may be copied from the portable storage device to the user's personal computer or other electronic devices as desired.

In some embodiments, the kiosk can comprise a computer system that is not owned or controlled by the user who wishes to acquire the digital content. Examples of these kiosks include computer terminals located on college campuses, in libraries, in copy and print shops, in airports, or in other public or private locations. In these instances, the user may have access to the digital content, optionally via a network connection to a content server, but the user does not own or permanently control the device through which that content is available.

The digital content and the associated DRM information can also be used with any system that contains these devices, including any system containing a kiosk. An example of one system for delivering digital content having associated DRM information is illustrated in FIG. 3. As depicted in FIG. 3, the system 85 contains various devices on which the digital content and the associated DRM information can be present.

The system 85 contains both a first device, a second device, and means for transferring the digital content from the first device to the second device (or vice versa). One example of the first device comprises a kiosk 86 (or a plurality of kiosks), where kiosk 86 comprises computer components that include means for storing the digital content or for obtaining the digital content in real time from another source such as content server 82. Examples of means for storing the digital content which may be present in kiosk 86 include optical storage discs, DVD-RAM discs, and traditional magnetic hard disc drives. The kiosk 86 may comprise a single computer processing unit or multiple computer processing units, with each one implementing one or more tasks and communicating among themselves using standard networking protocols.

The system also contains a second device. The second device can comprise and device or apparatus that is capable of storing and/or using the digital content. In some aspects, the second device comprises a portable storage device 88 or portable viewer/player 92 as depicted in FIG. 3. The portable storage device may comprise a USB-based solid state storage device, such as a flash-drive, thumb-drive, keychain drive, or similar device; or other portable storage devices, including Compact Flash cards, Secure Digital cards, Memory Stick cards, or other similar technologies. A portable storage device may also comprise magnetic or optical storage technologies as known in the art, including CDs and DVDs. The portable viewer/player 92 may comprise a portable music player (such as an iPod or similar player) or a portable electronic document viewing device (such as an e-book reader), a mobile or cellular telephone, a personal digital assistant (such as a Palm Pilot, iPaq, Blackberry device), or similar devices using any technology, operating system, or configuration known in the art.

The system 85 can optionally contain a third device that assists any of the functions and/or operations of the first device or the second device. One example of the third device comprises a server. Examples of servers that can be used include a computer running a UNIX-style operating system, a computer running a Microsoft Windows, Apple, or Linux operating system, a personal computer workstation, as well as license server 80, content server 82, and payment server 84. The server comprises any storage component on which the digital content can be stored. Examples of storage components include optical storage discs, DVD-RAM discs, and traditional magnetic hard disc drives. Another example of the third device is any kind of computing device that can store and optionally manage any digital content.

In some aspects, multiple servers 87 may be connected together to make a server cluster for the third device. Using a server cluster permits sharing information regarding the content stored on each server and each transaction the server has recorded. By using a server cluster, the system 85 can always be operational, regardless of the location of a particular component on the network that connects the components (such as the Internet). The server cluster can contain a primary cluster, which handles all critical tasks, with minor functions being routed to a secondary cluster. With this configuration, if the primary cluster is not operational, most functions can be handled by the secondary cluster. A server cluster also allows a large-scale deployment and interoperability, as well as data that can be stored on the network in multiple points of co-location.

The software components required for operating the system 85 can be distributed on either the first device or the third device. In some instances, the software may be included on a single server or on multiple servers, with each server implementing one or more tasks and communicating among themselves using standard networking protocols. Non-limiting examples of the server-focused tasks using the software components that may be implemented on one or more servers include those of email server; Web server; file server; purchase transaction authentication server; content security server; and advertising message server.

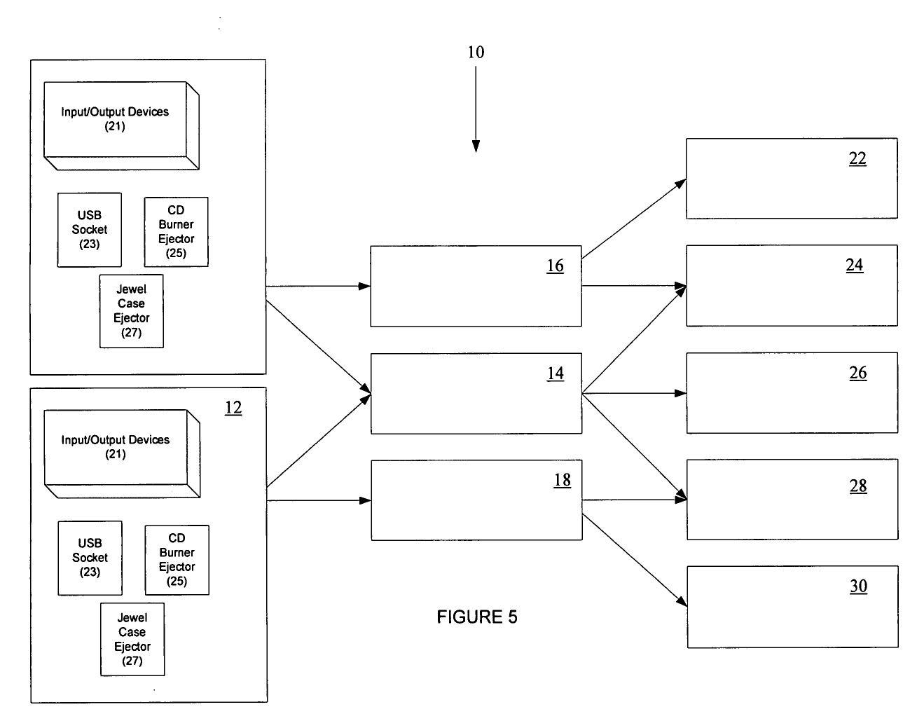

In other embodiments, the system need only contain the first and second devices as illustrated in FIG. 5. As shown in FIG. 5, the system 10 contains one or more first devices (i.e., kiosks 12) that can be used to distribute digital content onto any number of second devices. Examples of the second devices include a magnetic or optical storage device 14 (like a CD or DVD), a portable storage device (like a USB flash drive) 16, neither of which can use the digital content. Another example of the second device is a portable device 18 that can use/play the digital content (like an iPod or an e-book reader) as well as store the content.

The selected digital content (along with the DRM information and any other information) is transferred from the first device to the second device. For the storage device 14, the user receives the user receives the magnetic or optical storage device 14 containing the digital content from a corresponding receptacle in the kiosk, i.e., CD/DVD burner ejector 25. Optionally, a jewel case (or any other type of enclosure) for the storage device 14 can be received from the kiosk. And for the portable storage device 16 and/or the portable device 18, the digital content is transferred form the kiosk 12 using any electronic connection, such as USB socket 23. The kiosk 12 can encrypt the selected content with the DRM information and record it onto these devices 14 during the transfer process.

Thus, in some instances the user can use the second device to immediately access/use that digital content, i.e., read a digital copy of a book. Since the DRM information is associated with digital content, and not the portable device 14, the second device can access and/or use the digital content quickly and easily.

In other instances, though, the second device merely stores the digital content and it must transfer the digital content to a fourth device that is capable of using/accessing the digital content. Examples of the fourth device include a personal computer 22 or a component of a personal computer, a server (or server cluster) 24, an audio system 26 such as home entertainment center, a video system 28 such as a digital video recorder, or digital video player 30. Of course, the fourth device itself can also be a portable storage device that it turns accesses/uses the digital content or merely stores it to transfer to a fifth device (that can be any of the disclosed above)

As shown in FIG. 5, a user can interact with the kiosk 12 and provide a portable music player 18. Upon downloading the digital content comprising a music file from the kiosk 12 to the portable music player 18, the music is fully licensed and protected and may be played on the portable music player 18 without further action on the part of the user.

As well, a user can interact with the kiosk 12 and provide a portable USB storage device 16. Upon downloading the digital content comprising a music file from the kiosk 12, the user may connect the USB storage device to the personal computer, transfer the digital content, and user the hardware/software on the personal computer to play that music. When the personal computer accesses the digital content, that computer contacts the server (not shown in FIG. 5) and obtains a license granting rights to use the music file on that personal computer, typically via acquisition of a license that is associated with that personal computer.

The devices and systems described above can be used to carry out several methods. The first such method comprises protecting the digital content. Typically, the digital content can be protected by associating the DRM information with the digital content using any desired parameter or combination of parameters. In some aspects, this parameter can be specific to a given user or known only to that user. Examples of such information may include a user's name, a username associated with an account, a number associated with an account controlled by the user, a password, a pass phrase, an email address, a pre-selected code number, a telephone number, a social security number or other government-issued identification number, or other like information (collectively or individually, a user code). A user code can be distinguished from information that is associated with a given device or type of devices (a “device code”), such as a serial number, embedded address number (such as the MAC address of an Ethernet networking card), processor code, manufacturing identification number, inspection code, or any information that is associated with a specific device.

Another parameter that can be used to associate the DRM information with the digital content can include a transactional code. Typically, the transactional code may be generated or provided before or during that transaction in which the digital content is acquired by a user. Other parameters that can be used include conventional license information, date of the transaction, the amount of the transaction, an identifying code for the device on which the transaction took place, a unique content identifier, or a combination thereof.

In some aspects of this method, the first device (i.e., kiosk) can prepare the digital content for transfer to a second device (i.e., portable device) by acquiring the DRM information sufficient to permit the requested use of the digital content and then associating that information with the parameter (i.e., user code or transactional code). This association may be done using any technique known in the art, including encryption, hashing functions, simple look-up association, or key generation. In other aspects of this method, the third device (i.e., server) can prepare the digital content for transfer to the second device (i.e., kiosk) using similar methods. In other words, this method can be carried out at the server, the kiosk, or both. In the latter instance, both the server and the kiosk associated certain parts of the DRM information with the digital content.

The next method that can be carried using the system and devices described above is to transfer the protected digital content. Typically, but not exclusively, the digital content is transferred only after it has been protected or partially protected. The system can transfer the protected digital content from the third device (i.e., server) to the first device (i.e., kiosk) using means well known in the art. Non-limiting examples of these technologies include Ethernet, frame relay, DSL, satellite uplink, cable modem, analog modem, fiber channel, infrared and microwave transmissions, wireless communications of various types, and other networking technologies. Such connections may also be constructed through a publicly accessible network, such as the Internet, so long as appropriate security measures are used to prevent unauthorized access to the digital content that passes across the connection. A private network connection may also be used in order to reduce the reliance on such security measures and to further ensure the integrity of content that is transferred via this connection.

The system can also transfer the protected digital content between the first device (i.e., kiosk) and the second device (i.e., portable device) using any technologies known in the art. These technologies include wireless transfers, network transfers via any protocol, and bus transfers between devices attached to the same computer processing unit via connectivity such as USB port, FireWire IEEE-1394, serial port, parallel port, PCMCIA, CompactFlash, SecureDigital, or like ports or means of electronic connectivity. In some embodiments, the system can also transfer the protected digital content between the third device (e.g., server) and the second device (e.g., portable device), also using means well known in the art as set forth above. Similar technologies can be used when transferring the digital content to the fourth (or fifth or sixth, etc . . . ) device.

Yet another method comprises the use of the protected digital content. Once the protected digital content has been transferred to the second device (i.e., portable device), it can be used according by the user according to the DRM information that has been associated with that content. Of course, the methods of use will depend on the type of the digital content: for music, it can be played; for books, it can be read; etc. But the use of the digital content is limited by the restrictions in the DRM information. In some embodiments, the DRM information can be configured to become linked to, or associated with, the characteristics of the portable device. When the DRM information is also linked to the portable device, it can add another layer of protection to any other digital content that is used on that portable device.

As well, the protected digital content can be further transferred or distributed to other devices that are not connected to the systems described above. Since the DRM information is linked to the digital content and not dependent on the individual portable device to which the digital content was initially transferred, the DRM information can be automatically transferred with the digital content. Even if the DRM information is linked to any given portable device, it still remains linked to the digital content and so is transferred with the digital content regardless of the number of times the digital content is transferred. Depending on the nature of the DRM information, the nature of the digital content, the nature of the digital storage, or the structure of the files or file system used, the link between the digital content and the DRM information may temporarily become unlinked or unassociated and then re-linked or re-associated as desired.

Still yet another method involves the management of all the rights contained in the DRM. In this method, the system allows an operator to control the rights and restrictions associated with any digital content whenever a user, or a portable electronic device, accesses the system or a kiosk. For example, the first time a user accesses a kiosk, the system can configure the DRM information for any downloaded content with a first configuration. The next time the user accessed the same (or any other) kiosk; the system can keep the first configuration or set a second configuration based on the use of the digital content.

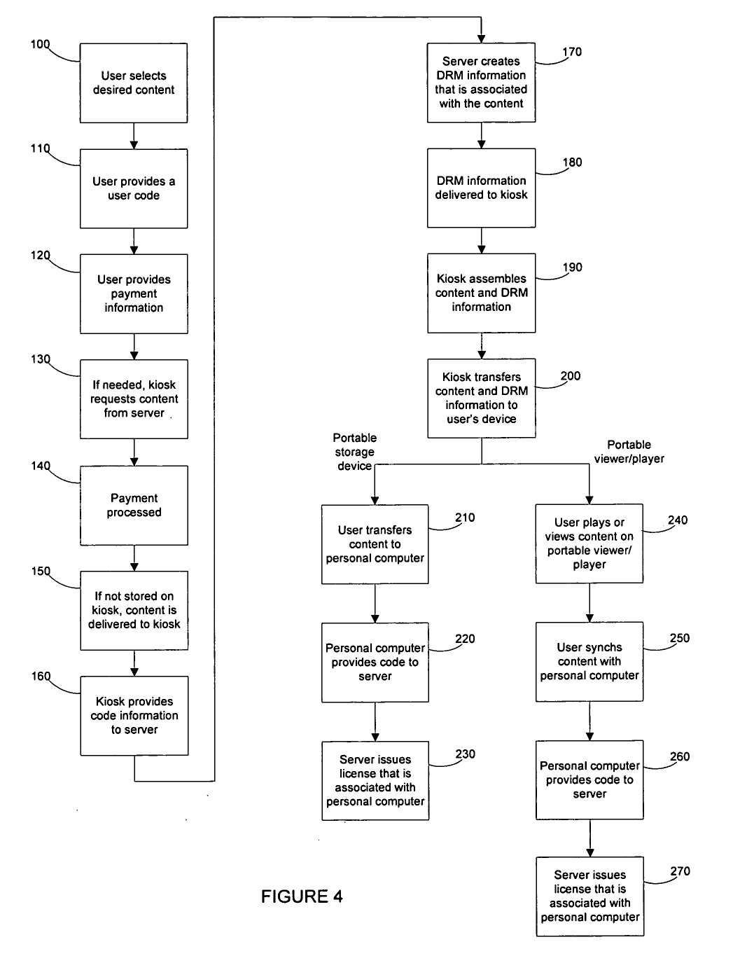

One example of these various methods is depicted in FIG. 4. This method begins at 100 where a user working at a kiosk selects desired digital content. Then at 110, the user provides a user code to the kiosk. The user may optionally provide one or more user codes of various types to the kiosk at various points, so long as the kiosk has obtained at least one user code before that user code is needed to establish an association with license information. In some instances, the kiosk may obtain a user code using other means rather than from the user directly. For example, the user may provide information that permits the kiosk to identify the user in some manner, whether biometrically or using any other type of personal information, the kiosk may have the ability to acquire a user code via information previously stored at the kiosk, or the server.

Next at 120, the user may pay for the right to access, use, or acquire digital content prior to receiving the digital content. This may be accomplished by providing any suitable payment information, such as a credit card number and related information. The kiosk is able to complete a purchase transaction by interacting with a payment server, transaction server or similar device. Alternatively, the user may have acquired credit of another type, including credit issued by the operator of the kiosk, a content provider, or another partner, which permits the user to acquire digital content without payment of money. In another embodiment, the digital content can be provided to the user without payment if the operator of the system (or kiosk) desires, i.e., as a promotion, gift, refund, or otherwise.

Then at 130, the kiosk obtains the digital content requested by the user. In some embodiments, the content requested by the user is stored on the kiosk. In other embodiments, the content is stored at a location remote from the kiosk and the kiosk obtains the content using the transfer methods described above. If necessary at 140, the kiosk may optionally use the payment information provided by the user to pay for the content. At 150, if requested by the kiosk, the content is then delivered to the kiosk from a location that may be remote from the kiosks.

Next at 160, the kiosk provides the user code (of other identifying information) to the server. The kiosk may optionally provide a transaction or identification code that can be used in conjunction with the user code to create the DRM information. In some embodiments, the transaction or identification code may be acquired or generated by the server rather than by the kiosk. Then at 170, the server creates the DRM information that is associated with the user code, and optionally, with the transaction/identification code and the digital content. In some embodiments, the kiosk may create the DRM information associated with a user code without recourse to the server or other device. Where the server or other device is required, reference 180 shows that DRM information is delivered to the kiosk to permit completion of the transaction. Next, at 190, kiosk assembles the digital content and DRM information in any manner permitting them to be stored on the portable device.

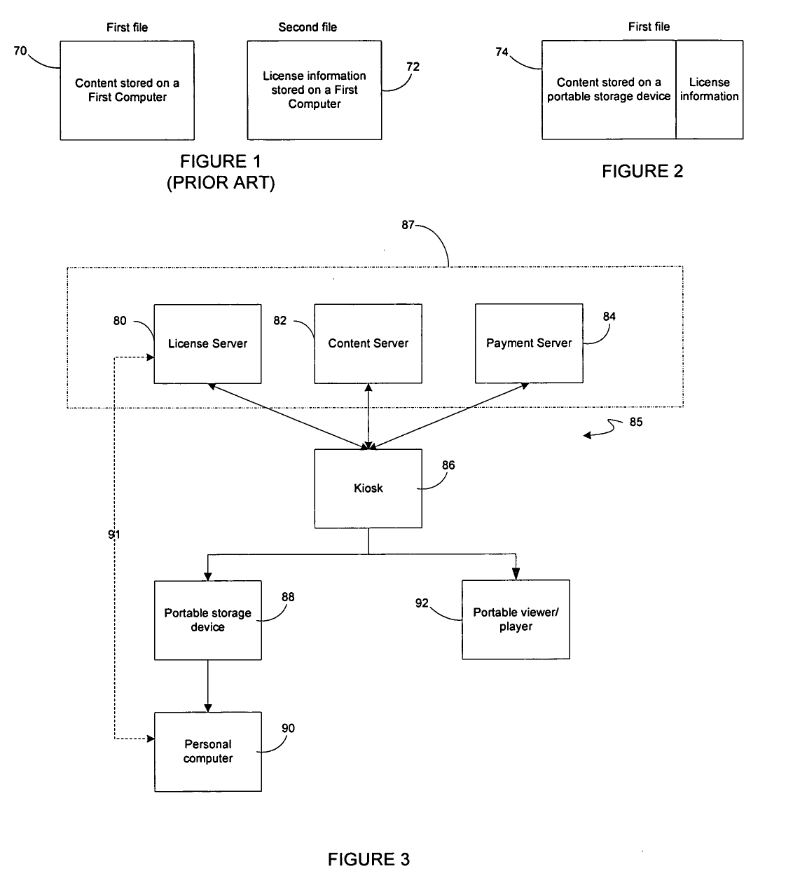

In some aspects, the nature of this DRM information and digital content is shown in FIG. 2, where the digital content and DRM information are contained within a single file 74. This compares to the prior art, as shown in FIG. 1, in which the digital content 70 and the DRM information 72 are stored in separate files. The ability to store both the digital content and DRM information in a single file permits both of these components to remain associated with one another during later steps in the method.

Then at 200, the content and DRM information are transferred to the user's device. As discussed above, this device is often a portable storage device or a portable viewer/player, as shown in FIG. 5. If the device comprises a portable storage device that is not capable of viewing or using the digital content, the user can transfer the digital content from the portable storage device to a personal computer, as shown at 210. This process may be accomplished entirely at the discretion of the user by selecting the time, place, and device onto which the digital content is transferred. The personal computer can then acquire the license information associated with that personal computer, as shown at references 220 and 230, just as if the information had been downloaded directly to the personal computer, but with the distinction that the DRM information is not reliant on that personal computer. Another distinction is that the user has selected the digital content at his or her convenience in a location remote from the user's personal computer.

When the user provides a portable viewer/player onto which digital content is transferred, the user may, as shown at reference 240, view or play the digital content acquired from the kiosk directly on that portable device. This is possible because the DRM information transferred from the kiosk to the device comprises a fully activated license that is provided during purchase or associated with the specific content and/or a specific user to which it was transferred.

As shown at 250, the user may choose to attach a portable viewer/player device to a personal computer and transfer or synch the digital content with that computer. The software and hardware running on that computer, at 260, may optionally be used to view or play the content after acquiring a license, at 270, for use on that computer.

These systems and methods described above have numerous advantages. One advantage is that the protected digital content have need not be restricted to a specific number or type of devices on which it can be used. As described above, a digital content provider typically defines a limited number or type of devices (i.e., computers) on which the digital content may be used after a license has been purchased by tying the license information to the specific device. In the systems and methods described above, the license information is not associated with the hardware or software of the device and thus does not “use up” one of the available copies. Thus, digital content can be downloaded to a device without creating an immediate link to that device. An added benefit is that a user can determine after purchase or acquisition of a license which device the user wishes to have associated with the digital content.

Another advantage is that the digital content can be used by the device in an isolated condition. With conventional systems, the license information that is linked to any given digital content prevents access to—and use of—the digital content until it is activated by connecting to a license server and then permission given to the device on which the digital content resides. With the present system, there is no need to connect to such a database to access or use the digital content. Thus, the digital content can be accessed and used even if the device is isolated and not connected to a license server.

An additional advantage of the present systems and methods include an increased flexibility. The kiosk may obtain content from a content server, may facilitate acquisition of a license from a license server, and may optionally require payment that may be facilitated through a payment server. The license, however, associated with the acquired digital content is associated with a user code (or other type of user-specific information) provided by the user, rather than a device code associated with the kiosk 86. This license is transferred to the portable storage device or portable viewer/player provided by the user, where the license remains associated solely with the user code provided by the user. Only when the user later selects a personal computer (or a similar device) onto which the digital content is transferred is it necessary for the software and/or hardware on that selected personal computer to acquire a license to the digital content that becomes associated with the device code.

Another advantage is that the digital content can be quickly and easily be transferred to numerous other devices while remaining protected. The user can utilize the systems to select that device with which each license will be associated, and is able to do so after completing the initial transaction in which the digital content is purchased or otherwise acquired.

In addition to any previously indicated variation, numerous other modifications and alternative arrangements may be devised by those skilled in the art without departing from the spirit and scope of the invention and appended claims, which are intended to cover such modifications and arrangements. Thus, while the invention has been described above with particularity and detail in connection with what is presently deemed to be the most practical and preferred aspects of the invention, it will be apparent to those of ordinary skill in the art that numerous modifications, including but not limited to, form, function, manner of operation and use may be made without departing from the principles and concepts set forth herein.

What is claimed is:

1. A method for protecting digital content, comprising:
providing digital content;
providing security information for the digital content that does not refer to the characteristics of any device on which the digital content may reside; and
associating the security information with the digital content.

2. The method of claim 1, wherein the digital content comprises music, video, ringtones, realtones, multimedia presentations, audio books, digital books, video games, mobile games, software, language learning programs, or combinations thereof.

3. The method of claim 1, wherein the security information is derived substantially from a transactional code or a user code.

4. The method of claim 1, wherein the association comprises a numeric association.

5. The method of claim 1, further comprising transferring the protected digital content from a first device to a second device.

6. The method of claim 5, wherein the first device is a kiosk, a Web page, or a standalone computer terminal.

7. The method of claim 5, wherein the second device is a portable storage device, a solid-state storage device, a magnetic storage device, a portable music player, a portable text viewing device, a personal digital assistant, or a mobile telephone.

8. The method of claim 3, wherein the security information is uniquely associated with the digital content, the user code, and the transactional code.

9. The method of claim 5, wherein the digital content is encrypted on the first device.

10. The method of claim 5, wherein the digital content is encrypted on the second device.

11. The method of claim 1, wherein the digital content and the security information comprise a single file.

12. The method of claim 1, wherein the security information comprises an activated license permitting access to the digital content.

13. Security information for digital content that does not refer to the characteristics of any device on which the digital content may reside.

14. The security information of claim 13, wherein it is derived substantially from a transactional code or a user code.

15. The security information of claim 13, wherein it is associated with digital content by means of a method comprising a hashing function, encryption, or database lookup.

16. Protected digital content, comprising security information that does not refer to the characteristics of any device on which the digital content may reside.

17. The content of claim 16, wherein the security information is derived substantially from a transactional code or a user code.

18. The content of claim 16, wherein the security information is associated with the digital content by a numeric association.

19. A device for protecting digital content, comprising:
means for providing digital content;
means for providing security information for the digital content that does not refer to the characteristics of any device on which the digital content may reside; and
means for associating the security information with the digital content.

20. A device for transferring digital content to a user, comprising:
means for providing digital content;
means for providing security information for the digital content that does not refer to the characteristics of any device on which the digital content may reside;
means for associating the security information with the digital content; and
means for transferring the protected digital content to a user device.

21. A system for providing secure access to digital content, comprising:
a first device capable of acquiring the digital content;
a second device capable of receiving the digital content;
a user code;
a transaction identification code; and
means for creating security information derived substantially from the user code, the digital content, and the transaction identification code, without reference to any uniquely identifying characteristics of the first device or of the second device, wherein the security information comprises an activated license permitting access to the digital content.

22. A method for transferring digital content, comprising:
providing digital content;
providing security information for the digital content that does not refer to the characteristics of any device on which the digital content may reside;
associating the security information with the digital content; and
transferring the protected digital content to a user device.

23. A method for protecting digital content, comprising:
providing digital content;
providing security information comprising information that is specific to a single user; and
associating the security information with the digital content.

24. The method of claim 23, wherein the security information comprises a transactional code or a user code.

25. The method of claim 24, wherein the security information is uniquely associated with the digital content, the user code, and the transactional code.
